(19) United States
(12) Patent Application Publication
(10) Pub. No.: US 2015/0126701 A1
(43) Pub. Date: May 7, 2015

(54) METHOD FOR THE PRODUCTION OF POLYSULFONES, AND POLYSULFONES

(71) Applicant: EMS-PATENT AG, Domat/Ems (CH)

(72) Inventors: Hanns-Jörg Liedloff, Domat/Ems (CH); René Gisler, Chur (CH); Andreas Kaplan, Chur (CH)

(21) Appl. No.: 14/397,529

(22) PCT Filed: May 3, 2013
(86) PCT No.: PCT/EP2013/001310

§ 371 Date: Oct. 28, 2014

(30) Foreign Application Priority Data
May 11, 2012 (EP) 12167743.9

(51) Int. Cl. C08G 75/20

(52) U.S. Cl. CPC C08G 75/20
USPC 528/175

(57) ABSTRACT

The present invention relates to an improved method for the production of polysulfones, in particular for the production of polyether sulfones (PESU) and polyphenylene sulfones (PPSU), the solvent being N-methylpyrrolidone (NMP) or/and N-ethylpyrrolidone (NEP).

The present invention relates to an improved method for the production of polysulfones, in particular for the production of polyether sulfones (PESU) and polyphenylene sulfones (PPSU), the solvent being N-methylpyrrolidone (NMP) or/and M-ethylpyrrolidone (NEP).

Polysulfones belong to thermoplastic high-performance plastic materials and are used in a versatile manner in different spheres, such as for example automobile construction, medical technology, electronics, air travel and membrane technology. An overview of the possibilities of use of this polymer class is presented in the article by N. Inchaurondo-Nehm printed in 2008 in Edition 10 on pages 113 to 116 of the periodical “Plastic Materials”.

The methods known since the 1960s for production thereof provide the conversion of an aromatic dihydroxy compound with a dichlorodiaryl sulfone component in the presence of a base. In the course of the years, the production methods have been continuously developed further, NMP has proved to be a particularly suitable solvent. Alternatively, also NEP and possibly another N-alkylated pyrrolidone can be used. NMP or/and NEP require the use of potassium-, sodium- or calcium carbonate as base. Potassium carbonate (potash) is thereby preferred. A particular advantage of the combination of these N-alkylated pyrrolidones with the carbonates resides in the fact that the conversion of the aromatic dihydroxy compound with the dichlorodiaryl sulfone component is effected in one step and the technical apparatus expenditure for the polycondensation can be kept comparatively low.

EP 0 347 669 A2 describes a method for the production of high-molecular, aromatic polyether sulfones from diphenols and dihaloarenes which is characterised in that N-alkylated acid amides are used as solvent and hence the water produced during the reaction is removed azeotropically at the same time. This document teaches the use of N-alkylated acid amides themselves as azeotrope former.

In addition, CA 847963 A describes the use of sulphoxides and/or sulfones as solvent in the production of polyaryl sulfones.

EP 0135 130 A2 describes a method for the production of polysulfones by polycondensation of essentially equivalent quantities of 2,2-bis-(4-oxyphenyl)-propane, which can be replaced partially by further biphenols, with bis-(4-chlorophenyl)-sulfone which can be replaced partially by further dihalobenzene compounds. NMP is used as solvent and potassium carbonate as base. According to the disclosure of this document, azeotrope formers are not required, a negative effect on the reaction speed and the viscosity number is shown for toluene as entrainer on the basis of experimental data.

The method described in WO 2010/112508 A1 for the production of polybiphenyl sulfone polymers provides an excess of the aromatic dihydroxy compound. NMP is used as solvent and potassium carbonate as base. Here also, reference is made explicitly to the fact that reaction control is possible without an additional entrainer if NMP is used as solvent.

A series of commercial products such as e.g. PESU Radel A304P or PPSU Radel R-5000 NT are produced according to methods which use an excess of the dichlorophenyl sulfone component, generally dichlorodiphenyl sulfone (=DCDPS). The fact that DCDPS was used in excess for the production of these products emerges from the relatively high chlorine content of these polysulfones, at approx. 0.3 percent by weight, and the concentrations of chlorophenyl- or chlorine end groups which were calculated therefrom and are more than 80 mmol/kg polymer. In accordance with the high proportion of chlorine end groups of these Radel types, the hydroxyphenyl- or hydroxy end group concentrations thereof are less than 20 mmol/kg polymer. Determination of these phenolic OH groups was effected according to the method described by A. J. Wnuk; T. F. Davidson and J. E. McGrawth in Journal of Applied Polymer Science; Applied Polymer Symposium 34; 89-101 (1978). Because of the comparatively low hydroxy end group concentrations, alkylation of the hydroxyl groups with methylchloride or other alkyl halides is dispensed with in the case of the Radel types. This was verified by ¹H-NMR-spectroscopic tests on solutions of these polysulfones in CDCl₃ (apparatus: 400 MHz spectrometer by the company Bruker), the method is explained in detail further on.

In contrast to the Radel A and R types, in the production of commercially available PESU and PPSU types, Ultrason E and Ultrason P, DCDPS is used in deficit. The excess, resulting therefrom, of bivalent phenols 4,4′-dihydroxydiphenyl sulfone (bisphenol S) or 4,4′-biphenol(4,4′-dihydroxydiphenyl=DHDP) makes methylation necessary, as the results of end group analyses, listed in the following table, show.

TABLE 1*
End groups of commercially available polysulfones

| | | | | | Chlorine | Viscosity |
|---|---|---|---|---|---|---|
| | | End group concentrations [mmol/kg] | | | content | number |
| Type | Polymer | Chlorophenyl- | Hydroxyphenyl- | Methoxyphenyl- | [ppm] | [ml/g] |
| Radel | PESU | 90 | 15 | — | 3200 | 51 |
| A304P | | | | | | |
| NT | | | | | | |
| Radel | PESU | 106 | 26 | — | 3800 | 42 |
| A704P | | | | | | |
| NT | | | | | | |
| Ultrason | PESU | 42 | 7 | 72 | 1500 | 56 |
| E2020P | | | | | | |
| Radel R | PPSU | 86 | 15 | — | 3200 | 71 |
| 5000 NT | | | | | | |
| Ultrason | PPSU | 17 | 8 | 112 | 600 | 67 |
| P 3010 | | | | | | |

*determination of the end group concentrations, of the chlorine content and of the viscosity number was effected according to the methods described further on.

The advantage of the methods which provide a DCDPS excess resides in the fact that a reaction step, namely the alkylation of hydroxyphenyl end groups—usually with methylchloride—can be dispensed with and consequently the material- and process costs can be reduced. One disadvantage of these methods resides in their lower tolerance relative to process interruptions. In concrete terms, the disadvantage resides in the fact that the salt-containing polymer solutions which are found in the reactor, i.e. not yet freed of solid materials by means of filtration, are inclined towards increases in viscosity and molecular weight with extended dwell times in the reactor. In the case of a sufficiently long dwell time in the reactor, there are produced extremely highly-viscous polymers which are completely unusable for any of the above-described applications so that a material loss which can no longer be compensated for results.

Both the mentioned methods from the state of the art which provide an excess of the hydroxy component (EP 0 135 130 A2 and WO 2010/112508 A1) and methods which use a chlorine excess have the following common disadvantage:

the preferred implementation of the polycondensation of polysulfones [PESU, PPSU and polysulfone (based on DCDPS and bisphenol A)], supported by the state of the art, in the absence of an entrainer for separating the water produced during the conversion, has an excessively long reaction duration as a result, which has a disadvantageous effect on productivity and dimensioning of the polycondensation reactors and reduces the economic efficiency of the method.

It was therefore the object of the present invention to make available an improved method, which overcomes the mentioned disadvantage of the state of the art. This object is achieved by a production method having the features of claim 1 and also a polysulfone polymer having the features of patent claim 17.

The method according to the invention according to claim 1 of the present invention for the production of polysulfone polymers comprises the conversion of a component A, consisting of at least one aromatic dihydroxy compound, this aromatic dihydroxy compound comprising 4,4′-dihydroxybiphenyl and/or bisphenol S and a component B which comprises at least one bis-(haloaryl)sulfone, preferably 4,4″-dichlorodiphenyl sulfone (CAS#80-07-9); in a molar ratio of component A to component B of 0.95 to 0.99 to 1.00 or 1.01 to 1.05 to 1.00, the conversion being implemented in a solvent comprising N-alkylated pyrrolidones and an entrainer with a boiling point of greater than 130° C. being added to the reaction mixture. The conversion of component A with B is thereby effected in the presence of a base which reacts during the reaction with the mixture with water separation. The base thereby activates the dihydroxy compound (compound A) by deprotonation.

For the mechanistic progress of the reaction, the idea is that the base firstly activates the dihydroxy compound (component A) by deprotonation. After substitution of the chlorine atoms of the dichlorine compound (component B) by the anion of component A, hydrogen chloride is produced according to the formula, which is neutralised by the base with formation of the corresponding salt and water. When using e.g. potash as base, carbonic acid, which decomposes into water and carbon dioxide, and potassium chloride are thereby produced.

The water produced is thereby removed from the reaction mixture by distillation using an entrainer, in a preferred embodiment. There is understood thereby by an entrainer, preferably a substance which forms an azeotrope with water and it enables the water to be separated from the mixture. The entrainer is thereby materially different from the solvent. Preferably, the entrainer does not represent a solvent for the produced polysulfone whilst the solvent has no entrainer character.

Advantageous embodiments of this method are presented in sub-claims 2 to 15 and the following description.

As a result of the tests performed by the inventors, it was established that, during process interruptions after the conversion of the aromatic dihydroxy compound with the dichlorophenyl sulfone component, no increase in the molecular weight, up to polymers with unusable properties is observed if the aromatic dihydroxy component is used in a a molar excess relative to the dichlorophenyl sulfone component.

Preferably entrainers based on alkyl aromatic compounds, in particular alkylbenzenes, are used.

It was established by the inventors that in particular alkylbenzenes, which have a boiling point of greater than 130° C., have an excellent entrainer function. They curtail the reaction times significantly and hence increase the economic efficiency of the method. In view of the negative results from the state of the art with the simplest alkylbenzene, toluene (boiling point 111° C.), these findings are extremely surprising.

A non-restricting selection of alkyl aromatic compounds according to the present invention is listed in the following table together with their boiling temperatures.

TABLE 2
selection of entrainers according to the present invention

| Entrainer | Boiling temperature [° C.] |
|---|---|
| o-xylene(1,2-dimethylbenzene) | 144 |
| m-xylene(1,3-dimethylbenzene) | 139 |
| p-xylene(1,4-dimethylbenzene) | 138 |
| Ethylbenzene | 136 |
| Mixture of o-, m- and p-xylene and | 138.5 |
| ethylbenzene*⁾ | |
| Cumene = isopropylbenzene | 152 |
| Pseudocumene = 1,2,4-trimethylbenzene | 169 |
| Mesitylene = 1,3,5-trimethylbenzene | 165 |

*⁾Such mixtures are isolated from pyrolysis benzene (from steam cracker processes) or from reformate benzene (from reforming processes) and are subsequently termed commercial xylene.

The invention enables partial or complete removal of the water produced during the conversion of component A with component B, preferably by distillation-off from the reaction mixture and the polysulfone polymer which is being produced or is produced and contained therein. The water produced during the reaction can be removed as an azeotrope together with the entrainer out of the reaction mixture, for example by azeotropic distillation with the entrainer. A partial, preferably complete removal of the produced reaction water out of the reaction mixture is thereby achievable.

There is thereby understood by “complete” water removal that more than 95% of the formed reaction water is separated, preferably more than 98%. In this context, in the case of partial or complete removal of the entrainer, effected at this point, the term is “de-watering”. In the case where only a part of the entrainer is removed, for example distilled off, the remaining or excess entrainer can also be removed from the reaction mixture, for example likewise by distillation, at a later time.

In a particularly preferred embodiment, the entrainer is guided in the circulation during the azeotropic distillation. Water and entrainer are separated in the condensate and form a phase boundary, the water can be separated for example via a water separator outside the reactor in which the conversion of component A and component B is implemented. With the separated water, generally also a small part of the entrainer is thereby removed from the reaction mixture.

In the sense of the present invention, component A consists of at least one aromatic dihydroxy compound and comprises at least 4,4′-dihydroxybiphenyl and/or bisphenol S, 4,4′-dihydroxybiphenyl being preferred. Furthermore, component A can comprise further compounds, such as e.g. dihydroxybiphenyls, in particular 2,2′-dihydroxybiphenyl; further bisphenyl sulfones, in particular bis(3-hydroxyphenyl sulfone); dihydroxybenzenes, in particular hydroquinone and resorcine; dihydroxynaphthalenes, in particular 1,5-dihydroxynaphthalene, 1,6-dihydroxynaphthalene and 1,7-dihydroxynaphthalene; bisphenylether, in particular bis(4-hydroxyphenyl)ether and/or bis(2-hydroxyphenyl)ether; bis-phenylsulphides, in particular bis(4-hydroxyphenyl)sulphide; bisphenylketones, in particular bis(4-hydroxyphenyl)ketone; bisphenylmethanes, in particular bis(4-hydroxyphenyl)methane; bisphenylpropanes, in particular 2,2-bis(4-hydroxyphenyl)propane (bisphenol A); bisphenylhexafluoropropanes, in particular 2,2-bis(3,5-dimethyl-4-hydroxyphenyl)hexafluoropropane; and/or mixtures thereof.

In one embodiment of the present invention, component A comprises at least 50 percent by weight of 4,4′-dihydroxybiphenyl or at least 50 percent by weight of bisphenol S, preferably at least 80 percent by weight of 4,4′-dihydroxybiphenyl or bisphenol S are contained in component A, in a particularly preferred embodiment, component A is 4,4″-dihydroxybiphenyl or bisphenol S.

The component B which is used in the sense of the present invention comprises, in a particularly preferred embodiment, (4,4′-dichlorodiphenyl sulfone, the additional use of other diaryl sulfone compounds or replacement of 4,4-dichlorodiphenyl sulfone by other diaryl sulfone compounds are likewise in accord with the invention.

The conversion of component A and B is effected preferably between 80 and 250° C., further preferred between 100 and 220° C. and particularly preferred between 150 and 210° C.

The conversion of component A and B, expressed by the timespan in which reaction water is produced, is effected preferably between 1 and 6 hours, preferably between 1.5 and 5 hours and particularly preferred between 2 and 4 hours.

According to the present invention, component A is used in a molar ratio of 0.95 to 0.99 to 1.00 or 1.01 to 1.05 to 1.00 relative to component B. The molar excess or deficit of the components is therefore not more than 5% and not less than 1%. These excesses or deficits are preferably between 1 and 4%, particularly preferred between 1.5% and 3.5%. If molar excesses or deficits of more than 5% are used, products with low molecular weight are obtained, which are not suitable in practice for use due to the inadequate mechanical properties thereof. The use of molar excesses or deficits of less than 1% leads on the other hand to products with very high molecular weight which likewise have unusable mechanical properties.

An embodiment in which component A is used in the above-mentioned excesses is particularly preferred. As already mentioned, no uncontrolled increase in the molecular weight is observed for this embodiment in the case of process interruptions.

The quantity of entrainer is 4 to 12 percent by weight, preferably 5 to 10 percent by weight and particularly preferred 6 to 9 percent by weight, relative to the total weight of all the components, including the solvent and the base.

By reaction control according to the conditions of the method according to the invention, it is possible to obtain conversions of greater than 96%, preferably greater than 98% and particularly preferred greater than 98.5%. The conversions in the sense of the present invention relate to the molar proportion of the converted reactive chlorine- and hydroxy end groups of components A and B.

The conversion of components A and B is effected preferably in a solvent which comprises mainly N-alkylated pyrrolidones. A variant in which exclusively NMP or/and NEP is used as solvent is particularly preferred. An embodiment in which exclusively NMP is used as solvent is preferred in particular.

According to the present invention, the concentration of components A and B in the solvent is from 10 to 60 percent by weight, preferably from 15 to 50 percent by weight and particularly preferred from 20 to 40 percent by weight.

Entrainers in the sense of the present invention have a boiling point of greater than 130° C. Preferred entrainers are selected from the group consisting of ortho-xylene, meta-xylene, para-xylene, mixtures of xylene isomers, technical grade xylene, ethylbenzene, 1,3,5-trimethylbenzene, 1,2,4-trimethylbenzene and/or mixtures thereof. Technical grade xylene, by which there is understood a mixture of xylene isomers which occur for example in reforming- or steam cracker processes, and which comprises in addition ethylbenzene is particularly preferred. Reference is made to the fact that the solubility of the polysulfone polymers and also of the educts for their production in the entrainers is very low and these should therefore not be understood as solvent in the sense of the present invention. In addition, the N-alkylpyrrolidones which are outstandingly suitable as solvent have only an inadequate entrainer function and should in no way be understood as entrainer in the sense of the present invention.

In a preferred embodiment of the present invention, the conversion of component A with component B is effected in the presence of a base. This base has the purpose of converting the aromatic hydroxy component into the more reactive phenolate form. Preferred bases are alkali- or alkaline earth hydrogen carbonates, alkali- or alkaline earth carbonates or mixtures of the previously mentioned compounds, in particular sodium carbonate, potassium carbonate and calcium carbonate, potassium carbonate being particularly preferred. In a particularly preferred embodiment, water-free potassium carbonate is used. According to a further preferred embodiment, water-free potassium carbonate having a particle size of less than 250 μm is used. According to the present invention, 1.0 to 1.5 equivalent of the base, preferably 1.005 to 1.1 equivalent, particularly preferred from 1.008 to 1.05 equivalent of the base, respectively relative to 1.0 equivalent of component A, is used.

Although the pure polysulfones are known as very oxidation-stable compounds, the exact opposite applies as the inventors have established for the solutions of these polymers in NMP or in another solvent. Precisely due to traces of oxygen, the dissolved polysulfones, under the production conditions, i.e. at temperatures of approx. 150 to approx. 240° C., are decomposed very rapidly to form completely unusable, i.e. greatly discoloured and highly viscous products. The viscosity of oxidatively damaged polysulfones passes firstly through a minimum before, in the extreme case, crosslinking to form neither flowable nor meltable materials occurs. Therefore, the implementation of the polycondensation and of all subsequent steps under an extensively oxygen-free inert gas atmosphere is absolutely necessary. As protective gases, nitrogen and argon with an oxygen content of less than 100 ppm, preferably less than 10 ppm, in particular less than 1 ppm, have proved their worth.

A preferred embodiment of the present invention provides, during and/or after conversion of components A and B, single or multiple conversion of the polysulfone polymer with at least one aliphatic monohalogen compound (component C). The still present hydroxy groups are etherised in this reaction step and the polymer is protected from synthesis or decomposition reactions. In addition, this reaction step has a positive effect on the yellowing properties of the polymer. For preference, alkyl halides and particularly preferred alkyl chlorides are used, i.e. alkylation takes place during the conversion with component C. In a particularly preferred embodiment, methylchloride is used as component C.

The conversion with component C should be implemented preferably before the distillative removal of the excess entrainer (entrainer distillation).

The temperature during the conversion with component C, according to the present invention, is between 140 and 215° C., preferably between 160 and 205° C., particularly preferred between 180 and 200° C. Component C can be supplied continuously as a gas flow but also can be applied in batches. Provided component C is used in liquid form, a continuous feed is preferably effected. The conversion with component C is implemented between 15 and 200 minutes, preferably between 25 and 120 minutes, and particularly preferred between 30 and 60 minutes.

In a further embodiment of the present invention, a chain regulator (component D) is added during and/or after conversion of components A and B. As component D, activated aromatic organic monochloro compounds or monovalent phenols are possible. A compound selected from the group consisting of monochlorodiphenyl sulfone, 4-phenylphenol, 2-hydroxynaphthalene (β-naphthol) and/or 1-hydroxynaphthalene (-naphthol) or monochlorodiphenyl sulfone as individual substance or as mixture of at least two of the previously mentioned substances is particularly preferred.

The proportion of component D relative to the sum of components A and B is 0.01 to 10 percent by weight, preferably 0.05 to 3 percent by weight, and particularly preferred 0.1 to 0.75 percent by weight.

It has proved to be advantageous to filter off the potassium chloride produced during the conversion of component A and B after the reaction is completed. Provided a conversion with component C is effected, it is advantageous to implement the filtration only after this second reaction step. The filtration is effected after diluting the reaction mixture with the solvent used for the conversion to twice the volume.

The process duration in the sense of the present invention is for all polysulfones except PESU (bisphenol S as dihydroxy component) below 400 minutes, preferably below 350 minutes and particularly preferred below 310 minutes. For PESU, the process duration is somewhat higher because of the lower reaction speed and is below 450 minutes, preferably below 410 minutes and particularly preferred below 380 minutes. The term process duration is explained in the experimental part and, in addition to the duration of the conversion of component A and B, comprises also the steps of methylation and distillative removal of the excess entrainer.

The viscosity numbers of the polysulfones produced according to the method of the present invention are from 35 to 85 ml/g, preferably from 42 to 80 ml/g and particularly preferred from 45 to 70 ml/g, measured according to ISO 307.

The excess entrainer is removed, in a preferred embodiment, before precipitation of the polysulfone.

Precipitation of the obtained polysulfone can be effected, within the scope of the present invention, according to the techniques which are common for this class of substance. The precipitant is selected preferably from the group consisting of water, mixtures of water and NMP, water and NEP and/or alcohols with 2-4 C atoms. The proportion of the NMP or NEP in the mixtures with water is up to 25 percent by weight. For particular preference, the temperature of the precipitant is 80° C. if the precipitation is effected at normal pressure. At higher pressures, as can be required by design of the apparatus used for the precipitation, the temperature of the precipitant is higher than 100° C.

The subject of the present invention is likewise polysulfone polymers which are produced according to the previously described method.

The polysulfone polymer according to the invention thereby represents a polycondensate made of the monomers component A and component B which is terminated at the chain ends inter alia with groups which originate from component D.

According to the invention, likewise a thermoplastic moulding compound, comprising at least one previously mentioned polysulfone polymer, is indicated. In addition, the invention provides moulded articles, produced from a thermoplastic moulding compound according to the invention, in particular in the form of fibres, films, membranes or foams. The invention likewise relates to possibilities for use of a polysulfone polymer according to the invention or of a thermoplastic moulding compound according to the invention for the production of moulded articles, fibres, films, membranes or foams.

The present invention is explained in more detail with reference to the following examples which illustrate the invention but are not intended to restrict the scope thereof.

The materials listed in Table 3 were used in the examples and comparative examples.

TABLE 3
Materials used

| Substance | Trade name | Abbreviation | Manufacturer |
|---|---|---|---|
| 4,4′-dihydroxybiphenyl | 4,4′-biphenol | DHDP | Si-Group; |
| | | | Newport, |
| | | | Tennessee, US |
| 4,4′-dihydroxydiphenyl sulfone | bisphenol S | BPS | Jiangsu Aolunda |
| | | | High-Tech Ind; |
| | | | Fenshui, CN |
| 4,4-dichlorodiphenyl sulfone | 4,4′-dichlorodiphenyl sulfone | DCDPS | Ganesch |
| | | | Polychem. Ltd. |
| | | | Mumbai; India |
| 4-phenylphenol | 4-phenylphenol | — | Sigma Aldrich, |
| | | | Buchs, CH |
| potassium carbonate | potassium carbonate | — | EVONIK-Degussa |
| | | | GmbH; Lülsdorf, |
| | | | DE |
| methylchloride | methylchloride | MeCl | Sigma Aldrich, |
| | | | Buchs, CH |
| N-methylpyrrolidone | N-methylpyrrolidone | NMP | BASF AG, |
| | | | Ludwigshafen, DE |
| N-ethylpyrrolidone | N-ethylpyrrolidone | NEP | BASF AG, |
| | | | Ludwigshafen, DE |
| commercial xylene^{a)} | commercial xylene^{a)} | — | Total S.A., |
| | | | Courbevois, Paris |
| toluene | toluene | — | Sigma Aldrich, |
| | | | Buchs, CH |

^{a)}Proportion of ethylbenzene of <20%

Implementation of the Analytical Determinations and Sample Preparation

Sample Preparation

For preparation of the samples removed during or at the end of the polycondensations for implementation of the analyses, these were firstly precipitated with a large excess of water at a temperature of 80° C., the resulting polymer particles were then extracted twice with 100 times the quantity of water (21 to 20 g polymer) at 90° C. for 3 hours, dried for 14 hours at 100° C. in the vacuum drying cupboard and finally extracted for 16 hours in a high excess of boiling methanol (500 ml to 5 g polymer) and dried in a vacuum.

Determination of the Viscosity Numbers (VN)

Determination of the viscosity number in [ml/g] was effected according to ISO 307 at 25° C. on 1% solutions of the polymers in a 1:1 mixture of phenol and ortho-dichlorobenzene. In example E 2 and comparative example CE 2, furthermore an analogous determination in NMP as solvent was implemented. The viscosity numbers measured in NMP are indicated there in brackets.

Determination of the Hydroxy End Group Concentrations

The hydroxy end groups were determined according to the method of Wnuk et al. which was already cited above.

Determination of the Methoxy End Group Concentrations

The methoxy end groups were determined by means of ¹H-NMR spectroscopy on a 400 MHz apparatus of the company Bruker. The signals of the aromatic protons and also the signal for the protons of the methoxy group were integrated, the sum of the integral value of the aromatic protons being set at 16. The methoxy end groups were then calculated with the following formula:

$$EG ( methoxy ) = \frac{integral ( methoxy ) \times 1000000}{M \times 3}$$

with
EG (methoxy): methoxy end groups in μaeq/g
Integral (methoxy): integral of the signal at 3.85 ppm (integral of the aromatic protons set at 16)
M: weight of the repetition unit of the polysulfone in g/aeq (PPSU: 400 g/aeq, PESU: 464 g/aeq)

Determination of the Chlorine Content

The chlorine content was determined by means of ion chromatography. Firstly, the samples were prepared as follows:

in order to determine the total chlorine content, decomposition of the sample was implemented with an oxygen decomposition apparatus of the company IKA. 100 mg of the sample was weighed into an acetobutyrate capsule, provided with ignition wire and connected to both electrodes of the decomposition apparatus. As absorption solution, 10 ml of 30% hydrogen peroxide was used. The ignition was effected at 30 bar oxygen. The decomposition solution was filtered, filled into vials and finally analysed by ion chromatography for chloride.

In order to determine the free chloride, 2.0 g sample in 50 ml methanol/water 1/1 was extracted overnight with reflux. The extraction solution was filtered, filled into vials and analysed by ion chromatography for chloride.

The ion chromatography was implemented with the following parameters:
Apparatus: ICS-90 (company Dionex)
Column: IonPac AS12A Analytical Column (4×200 mm)
Eluent: 2.7 mM sodium carbonate 0.3 mM sodium hydrogen carbonate
Detection: Conductivity detector
Flow: 1 ml/min.
   The evaluation was effected with the method of the external standard. For this purpose, a calibration curve was determined from 3 different chloride solutions of known concentration.

Determination of the Chlorine End Group Concentrations

The chlorine end group concentrations were calculated according to the following formula via the chlorine content:

$$EG ( chlorine ) = \frac{[ chloride ( total ) - chloride ( free ) ]}{35.5}$$

with
EG (chlorine): chlorine end groups in μeaq/g
chloride (total): chloride concentration of the decomposition solution in ppm
chloride (free): chloride concentration of the extraction solution in ppm

### EXAMPLE 1

### E 1, Production of PPSU-1 with Commercial Xylene as Entrainer

In a heatable autoclave of the company Büchi (agitated vessel type 4, 2.0 l, Büchi A G, Uster) with agitator, connections for distillation attachments, reflux cooler, water separator and inert gas supply line, 84.82 g (0.4555 mol) 4,4′-dihydroxybiphenyl and 128.0 g (0.4457 mol) 4,4′-dichlorodiphenyl sulfone (molar ratio DHDP:DCDPS=1.022:1.000) were dissolved in 419 ml NMP under an argon atmosphere and converted, with the effect of 63.47 g (0.4587 mol) dispersed, in particular fine-particle potassium carbonate, in the presence of 60 g commercial xylene as entrainer, to form a polyphenylene sulfone which was methylated subsequently, as described below, with gaseous methylchloride. The speed of rotation of the agitator was set in all phases of the polymer production to 300 rpm. Firstly, the resulting water was removed with parts of the entrainer from the reaction mixture during 120 minutes at a temperature of 190° C. This process is subsequently termed “de-watering”. At the end of this process step, a sample of the polymer solution, which is sufficient for measurement of the viscosity number, was extracted (sample 1). Then the autoclave was closed and methylchloride was applied three times within 20 minutes at 190° C., so that respectively a pressure of 4 to 4.5 bar was set, this process step is subsequently termed “methylation”. At the end of the 1^{st} methylation, a sample is extracted for the viscosity measurement (sample 2). Thereafter the excess commercial xylene was distilled off within 65 minutes at 175-190° C., this process step is subsequently termed “entrainer distillation”. Finally, a 2^{nd} methylation was effected under the above-indicated conditions, this time within 30 minutes. After the end of the 2^{nd} methylation, a further sample was removed (sample 3). The three samples were prepared according to the above-described procedure. Measurement of the viscosity number (VN) of each of the three samples produced the following values.

| | VN [ml/g] |
|---|---|
| Sample 1: | 64 |
| Sample 2: | 65 |
| Sample 3: | 69 |

The number average molecular weight of sample 3 calculated from the chlorophenyl-, hydroxyphenyl- and methoxyphenyl end group concentrations—in total 142 mmol/kg—was 14085 g/mol. The time required in total for the polymer production was 235 minutes. There is understood by this time, provided nothing different is defined subsequently, the sum of the above-mentioned process steps “de-watering”, 1^{st} methylation, “entrainer distillation” and “2^{nd} methylation”, it is subsequently termed process duration. In the case of some examples and comparative examples, not all 4 process steps were implemented, the process duration was defined specially in the respective examples and comparative examples.

### COMPARATIVE EXAMPLE 1a

### CE 1a, Production of PPSU-1 with Toluene as Entrainer

In the same way as described under example 1, the same quantities of the components indicated there were converted to form a polyphenylene sulfone, this time however with toluene instead of the commercial xylene as entrainer. The individual process steps were implemented under the following conditions. After de-watering and at the end of the 1^{st} and 2^{nd} methylation, samples were removed and processed as described above (samples 1 to 3).

De-watering: Duration: 120 minutes/temperature: 190° C. (sample 1)

1^{st} methylation: Duration: 25 minutes/temperature 190° C. (sample 2)

Entrainer distillation: Duration: 45 minutes/temperature: 175-190° C.

2^{nd} methylation: Duration: 25 minutes/temperature 195° C. (sample 3)

Measurement of the viscosity number (VN) according to the above-described method of the three samples produced the following values.

| | VN [ml/g] |
|---|---|
| Sample 1: | 19 |
| Sample 2: | 21 |
| Sample 3: | 21 |

The number average molecular weight of sample 3 calculated from the end group concentrations (chlorophenyl-, hydroxyphenyl- and methoxyphenyl end group concentrations)—in total 950 mmol/kg—was 2005 g/mol. This material hence has at best an oligomeric character. The process duration was 215 minutes.

### COMPARATIVE EXAMPLE 1b

### CE 1b, Production of PPSU-1 without Entrainer

In the same way as described under example 1, the same quantities of the components indicated there were converted to form a polyphenylene sulfone, this time however without entrainer. The water produced during polycondensation was hereby as described in example 8 of WO 2010/112508 A1 distilled off within 6 hours directly from the reactor. The water vapour was thereby conducted to a reflux cooler with water separator via a line heated to 110-120° C. After methylation, a sample was taken. In contrast to E 1 and CE 1a, only one methylation was effected here.

De-watering: Duration: 360 minutes/temperature: 195° C.

Methylation: Duration: 60 minutes/temperature 195° C.

Determination of the viscosity number (VN) of the sample according to the above-indicated method produced the following values.

| | t[min] | VN[ml/g] |
|---|---|---|
| Sample 1: | 420 (after methylation) | 54 |

The viscosity number of example 1 after methylation was here, despite the long de-watering time, not achieved. The process duration (sum of the time for the process steps de-watering and methylation) was 420 minutes.

### EXAMPLE 2

### E 2, PPSU-2, Like Example 8 of WO 2010/112508 A1, Batch Reduced However to 20% and Commercial Xylene as Entrainer

In the apparatus described under example 1, 75.79 g (0.4070 mol) 4,4′-dihydroxybiphenyl and 114.83 g (0.3999 mol) 4,4′-dichlorodiphenyl sulfone (molar ratio DHDP:DCDPS=1.018:1.000) was dissolved in 420 ml NMP under an argon atmosphere and converted, under the effect of 57.22 g (0.4140 mol) dispersed, in particular fine-particle potassium carbonate in the presence of 53.5 g commercial xylene as entrainer, to form a polyphenylene sulfone, which as described in example 8 of WO 2010/112508 A1 was methylated by overhead conduction of methylchloride for one hour (flow: 3 l/h) at 130° C. The speed of rotation of the agitator was set during all of the process steps to 300 rpm. Samples for the viscosity measurement were removed before (sample 1) and after methylation (sample 2).

De-watering: Duration: 190 minutes/temperature: 190° C.

Entrainer distillation: Duration: 35 minutes/temperature: 190-200° C.

Methylation: Duration: 60 minutes/temperature: 130° C.

Measurement of the viscosity number of the two samples according to the method described in WO 2010/112508 A1 on 1% solutions in NMP at 25° C. produced the following values indicated in brackets. Furthermore, the viscosity numbers were determined in the above-indicated 1:1 mixture of phenol and ortho-dichlorobenzene mixture.

| | VN [ml/g] |
|---|---|
| Sample 1: | 65, (60) |
| Sample 2: | 66.5, (60.5) |

The process duration (sum of the time for the process steps de-watering, entrainer distillation and methylation) was 265 minutes.

### COMPARATIVE EXAMPLE 2

### CE 2, Production of PPSU-2 without Entrainer by Subsequent Processing of Example 8 of WO 2010/112508 A1

In the same way as described under example 2, the same quantities of the components indicated there were converted to form a polyphenylene sulfone, this time however without entrainer. As indicated in WO 2010/112508 A1, de-watering took place for 6 hours. Methylation was effected by overhead conduction of methylchloride for one hour at 130° C. For processing, the filtered PPSU solution after methylation was first precipitated with a 9:1 mixture of water and NMP, extracted according to the above-described method first with water and then with methanol and dried in a vacuum. Measurement of the viscosity number of the sample according to the method described in WO 2010/112508 A1 on 1% solutions in NMP at 25° C. produced the following values indicated in brackets. Furthermore, the viscosity numbers were determined in the above indicated 1:1 mixture of phenol and ortho-dichlorobenzene.

| | VN [ml/g] |
|---|---|
| Sample (after methylation): | 66, (60.5) |
| De-watering: | Duration: 360 minutes/temperature: 190° C. |
| Methylation: | Duration: 60 minutes/temperature 130° C. |

The process duration (sum of the time for de-watering and methylation) was 420 minutes. In example 2, a comparably high viscosity number was achieved, however the process duration was significantly less with only 285 minutes.

Observation: according to example 2, the process duration there was 265 min. Please check.

### EXAMPLE 3

### E 3, Production of PPSU-3; with Commercial Xylene as Entrainer and a Molar Excess of DCDPS

In the apparatus described under example 1, 127.36 g (0.6840 mol) 4,4′-dihydroxybiphenyl and 203.13 g (0.7074 mol) 4,4′-dichlorodiphenyl sulfone (molar ratio DHDP:DCDPS=0.9669:1.000) was dissolved in 657 ml NMP under an argon atmosphere and converted, under the effect of 98.76 g (0.7146 mol) dispersed, in particular fine-particle potassium carbonate in the presence of 90 g commercial xylene as entrainer, to form a polyphenylene sulfone. Since this PPSU concerns a polymer which is greatly controlled by DCDPS with correspondingly few hydroxyphenyl end groups, methylation was dispensed with.

De-watering: Duration: 280 minutes/temperature: 190° C.

Entrainer distillation: Duration: 25 minutes/temperature: 190-200° C.

A sample was removed at the end of the entrainer distillation and analysed according to the above-described methods. In addition to the viscosity number, also the chlorophenyl end group concentration and the hydroxyphenyl end group concentration were determined. A sample was taken after the entrainer distillation and processed as described above.

| | | Cl-phenyl | OH-phenyl |
|---|---|---|---|
| | VN [ml/g] | [mmol/kg] | [mmol/kg] |
| Sample: | 59 | 130 | 25 |

The process duration (sum of the time for de-watering and entrainer distillation) was 305 minutes.

### COMPARATIVE EXAMPLE 3

### CE 3a, Production of PPSU-3; with Toluene as Entrainer

In the same way as described under example 3, the same quantities of the components indicated there were converted to form a polyphenylene sulfone, this time however with 90 g toluene as entrainer. A sample was taken after entrainer distillation and processed as described above.

| | |
|---|---|
| De-watering: | Duration: 280 minutes/temperature: 190° C. |
| Entrainer distillation: | Duration: 25 minutes/temperature: 190-200° C. |

The viscosity number of the polymer determined according to the above-described method was 35 ml/g.

The process duration (sum of the time for de-watering and entrainer distillation) was, as in the case of example 3, 305 minutes, the viscosity number of example 3 was however nowhere near achieved.

### COMPARATIVE EXAMPLE 3

### CE 3b, Production of PPSU-3; without Entrainer

In the same way as described under example 3, the same quantities of the components indicated there were converted to form a polyphenylene sulfone, this time however without entrainer. As indicated in WO 2010/112508 A1, de-watering took place for 6 hours. For processing, the filtered PPSU solution was first precipitated with a 9:1 mixture of water and NMP, extracted according to the above mentioned method first with water and then with methanol and dried in a vacuum. The viscosity number was determined according to the above-indicated method in a 1:1 mixture of phenol and ortho-dichlorobenzene mixture.

| | VN [ml/g] |
|---|---|
| Sample (after methylation): | 53 |
| De-watering: | Duration: 360 minutes/temperature: 190° C. |

The process duration (time for de-watering) was 360 minutes.

### EXAMPLE 4

### E 4, Production of PPSU-1 in NEP Instead of NMP with Commercial Xylene as Entrainer

In the same way as described under example 1, the same quantities of the components indicated there were converted to form a polyphenylene sulfone. Commercial xylene was used as entrainer and NEP as solvent instead of NMP. The individual steps of the polymer production were implemented under the following conditions. After de-watering and at the end of the 1^{st} and 2^{nd} methylation, again samples were removed (sample 1 to 3).

De-watering: Duration: 180 minutes/temperature: 190° C. (sample 1)

1^{st} Methylation: Duration: 30 minutes/temperature: 190° C. (sample 2)

Entrainer distillation: Duration: 45 minutes/temperature: 195-205° C.

2^{nd} Methylation: Duration: 30 minutes/temperature: 195° C. (sample 3)

The three samples were processed according to the above-described procedure. Measurement of the viscosity number (VN) according to the above-indicated method produced the following values.

| | VN [ml/g] |
|---|---|
| Sample 1: | 56 |
| Sample 2: | 57 |
| Sample 3: | 58 |

The process duration was 285 minutes.

### COMPARATIVE EXAMPLE 4

### CE 4, Production of PPSU-1 in NEP Instead of NMP with Toluene as Entrainer

In the same way as described under example 1, the same quantities of the components indicated there were converted to form a polyphenylene sulfone, with toluene as entrainer and—as in example 4 with NEP as solvent. The individual steps of the polymer production were implemented under the same conditions as in example 4. After de-watering and at the end of the 1^{st} and 2^{nd} methylation, samples were removed again and processed as described above (sample 1-3).

De-watering: Duration: 180 minutes/temperature: 190° C. (sample 1)

1^{st} Methylation: Duration: 30 minutes/temperature: 190° C. (sample 2)

Entrainer distillation: Duration: 80 minutes/temperature: 205° C.

2^{nd} Methylation: Duration: 30 minutes/temperature: 195° C. (sample 3)

It is noteworthy that the distilling-off of the toluene from the reaction mixture took place comparatively slowly. In order to remove the entrainer mixture from example 4 (commercial xylene) under the same conditions distillatively from the reactor, only approximately half the time was required.

The three samples had the following viscosity numbers determined according to the above-indicated method.

| | VN [ml/g] |
|---|---|
| Sample 1: | 33 |
| Sample 2: | 33 |
| Sample 3: | 35 |

The process duration was 320 minutes.

### EXAMPLE 5

### E 5, Production of PESU in NMP with Commercial Xylene as Entrainer

In the apparatus described under example 1, 115.27 g (0.46056 mol) 4,4′-dihydroxybiphenyl sulfone and 130.95 g (0.4560 mol) 4,4′-dichlorodiphenyl sulfone (molar ratio BPS:DCDPS=1.010:1.000) was dissolved in 495 ml NMP under an argon atmosphere and converted, under the effect of 63.66 g (0.4606 mol) dispersed, in particular fine-particle potassium carbonate in the presence of 60 g commercial xylene as entrainer, to form a polyether sulfone. On this PESU type, the increase in the viscosity after de-watering was tested, for which purpose methylation, which leads to termination or to significant slowing of polycondenstion, was dispensed with. The sample removal was effected 60 minutes and 150 minutes after entrainer distillation.

De-watering: Duration: 260 minutes/temperature: 190° C.

Entrainer distillation: Duration: 50 minutes/temperature: 185-195° C.

The two samples processed as described above had the following viscosity numbers determined according to the above-indicated method.

| | VN [ml/g] |
|---|---|
| Sample 1 (60 min): | 59 |
| Sample 2 (150 min): | 67 |

Up to taking the 1^{st} sample, the process duration (sum of de-watering, entrainer condensation and one hour's waiting time) was 370 minutes.

### COMPARATIVE EXAMPLE 5

### CE 5, Production of PESU in NMP with Tolulene as Entrainer

In the same way as described under example 5, the same quantities of the components indicated there were converted to form a polyether sulfone, this time with toluene instead of commercial xylene as entrainer. 60 minutes and 150 minutes after the end of the entrainer distillation, two samples were extracted on which the viscosity number was determined according to the above-indicated method. Analysis of a third sample was dispensed with, since no further viscosity increase in the very low-viscosity reaction solution could be detected visually.

| | |
|---|---|
| De-watering: | Duration: 260 minutes/temperature: 190° C. |
| Entrainer distillation: | Duration: 50 minutes/temperature: 185-195° C. |

The two samples had the following viscosity numbers:

| | VN [ml/g] |
|---|---|
| Sample 1 (60 min): | 33 |
| Sample 2 (150 min): | 37 |

The process duration (sum of the time for the process steps de-watering and entrainer distillation and also one hour's waiting time) was 370 minutes.

TABLE 4
Overview of the results of examples (E) and comparative example (CE)

| Property | E 1 | CE 1a | CE 1b | E 2 | CE 2 | E 3 | CE 3a | CE 3b | E 4 | CE4 | E 5 | CE 5 |
|---|---|---|---|---|---|---|---|---|---|---|---|---|
| Polymer | PPSU-1 | PPSU-1 | PPSU-1 | PPSU-2 | PPSU-2 | PPSU-3 | PPSU-3 | PPSU-3 | PPSU-1 | PPSU-1 | PESU | PESU |
| Molar ratio | 1.022: | 1.022: | 1.022: | 1.018: | 1.018: | 0.9669: | 0.9669: | 0.9669: | 1.022: | 1.022: | — | — |
| DHBP:DCDPS | 1.000 | 1.000 | 1.000 | 1.000 | 1.000 | 1.000 | 1.000 | 1.000 | 1.000 | 1.000 | | |
| Molar ratio | — | — | — | — | — | — | — | — | — | — | 1.010: | 1.010: |
| BPS:DCDPS | | | | | | | | | | | 1.000 | 1.000 |
| Solvent | NMP | NMP | NMP | NMP | NMP | NMP | NMP | NMP | NEP | NEP | NMP | NMP |
| Entrainer | xylene^{a} | toluene | — | xylene^{a} | — | xylene^{a} | toluene | — | xylene^{a} | toluene | xylene^{a} | toluene |
| De-watering [min] | 120 | 120 | 360 | 190 | 360 | 280 | 280 | 360 | 180 | 180 | 260 | 260 |
| 1^{st} methylation | 20 | 25 | 60 | 60 | 60 | — | — | — | 30 | 30 | — | — |
| [min] | | | | | | | | | | | | |
| Entrainer | 65 | 45 | — | 35 | — | 25 | 25 | — | 45 | 80 | 50 | 50 |
| distillation [min] | | | | | | | | | | | | |
| 2^{nd} methylation | 30 | 25 | — | — | — | — | — | — | 30 | 30 | — | — |
| [min] | | | | | | | | | | | | |
| Process duration | 235 | 215 | 420 | 285 | 420 | 305 | 305 | 360 | 285 | 320 | 370^{b} | 370^{b} |
| [min] | | | | | | | | | | | | |
| Viscosity number | | | | | | | | | | | | |
| [ml/g] | | | | | | | | | | | | |
| Sample 1: | 64 | 19 | 54 | 65(60)^{c} | 66(60.5)^{c} | 59 | 35 | 53 | 56 | 33 | 59 | 33 |
| Sample 2: | 65 | 21 | — | 66.5 | — | — | — | — | 57 | 33 | 67 | 37 |
| Sample 3: | 69 | 21 | — | (60.5)^{c} | — | — | — | — | 58 | 35 | — | — |

^{a}commercial xylene;
^{b}up to taking 1^{st} sample (60 minutes after the end of the entrainer distillation);
^{c}viscosity number determined in NMP, all other viscosity numbers were determined in a 1:1 mixture of phenol/ortho-dichlorobenzene.

1. A method for the production of polysulfone polymers, in which a component A, comprising at least one aromatic dihydroxy compound, selected from the group consisting of 4,4′-dihydroxybiphenyl and/or bisphenol S, is converted with a component B, comprising at least one bis-(haloaryl)sulfone in the presence of a base which reacts with the reaction mixture under formation of water, wherein
0.95 to 0.99 or 1.01 to 1.05 equivalents of component A are used relative to 1.0 equivalent of component B,
the conversion is implemented in a solvent, comprising N-alkylated pyrrolidones, and
at least one entrainer with a boiling point of greater than 130° C. is added to this reaction mixture.

2. The method according to claim 1, wherein, during and/or after conversion of component A with component B, partial or complete de-watering of the reaction mixture is effected.

3. The method according to claim 1, wherein the entrainer is added in a quantity of 4 to 12 percent by weight relative to the total weight of all the components of the reaction mixture.

4. The method according to claim 1, wherein the entrainer with a boiling point of greater than 130° C. is selected from alkyl aromatic compounds.

5. The method according to claim 1, wherein component A is added in molar excess and the molar excess of component A relative to component B is between 1 and 5%.

6. The method according to claim 1, wherein during and/or after the conversion of components A and B, at least once a component C, which is an aliphatic monochloro compound is added to the reaction mixture to carry out alkylation.

7. The method according to claim 1, wherein during and/or after the conversion of components A and B, a conversion with a component D, which is an aromatic organic halogen compound or a monovalent phenol, is effected, component D is selected from the group consisting of 4-phenylphenol, 1-hydroxynaphthalene and/or 2-hydroxynaphthalene or component D being monochlorodiphenyl sulfone.

8. The method according to claim 7, wherein, before the addition and conversion of component C and/or of component D, at least part or the entirety of the water formed is removed from the reaction mixture and/or, after the conversion of component C and/or of component D, complete removal of the entrainer from the reaction mixture is effected.

9. The method according to claim 1, wherein the base is selected from the group consisting of alkali- or alkaline earth hydrogen carbonates, alkali- or alkaline earth carbonates, and mixtures thereof.

10. The method according to claim 9, wherein 1.0 to 1.5 equivalents of the base, relative to 1.0 equivalent of component A, are used.

11. The method according to claim 1, wherein the conversion of component A with component B is implemented under an inert gas atmosphere.

12. The method according to claim 1, wherein the sum of 4,4′-dihydroxybiphenyl and/or 4,4′-bisphenol S makes up at least 50 percent by weight of component A.

13. The method according to claim 1, wherein component A is 4,4′-dihydroxybiphenyl.

14. The method according to claim 1, wherein component A is 4,4′-bisphenol S.

15. The method according to claim 1, wherein the process duration, by which the entire duration for the steps of de-watering, entrainer distillation and alkylation is understood, is below 400 minutes.

16. The method according to claim 1, wherein the process duration, by which the entire duration for the steps of de-watering, entrainer distillation and alkylation is understood, is below 450 minutes.

17. A polysulfone polymer produced according to the method of claim 1.

18. The method according to claim 3, wherein the entrainer is added in a quantity of 5 to 10 percent by weight relative to the total weight of all the components of the reaction mixture.

19. The method according to claim 4, wherein the entrainer with a boiling point of greater than 130° C. is selected from the group consisting of alkylbenzenes, ortho-xylene, meta-xylene, para-xylene, mixtures of the xylene isomers, technical grade xylene, ethylbenzene, isopropylbenzene, 1,3,5-trimethylbenzene, 1,2,4-trimethylbenzene and/or mixtures thereof.

20. The method according to claim 5, wherein component A is added in molar excess and the molar excess of component A relative to component B is between 1 and 4%.
